(19) United States
(12) Patent Application Publication
(10) Pub. No.: US 2012/0280898 A1
(43) Pub. Date: Nov. 8, 2012

(54) METHOD, APPARATUS AND COMPUTER PROGRAM PRODUCT FOR CONTROLLING INFORMATION DETAIL IN A MULTI-DEVICE ENVIRONMENT

(75) Inventors: Andrés Lucero, Tampere (FI); Tero Jokela, Tampere (FI); Jussi Holopainen, Tampere (FI); Juha Arrasvuori, Tampere (FI)

(73) Assignee: Nokia Corporation, Espoo (FI)

(21) Appl. No.: 13/099,631

(22) Filed: May 3, 2011

(51) Int. Cl. G09G 5/00

(52) U.S. Cl. 345/156

(57) ABSTRACT

A method is provided for controlling information detail in a multi-device environment. In particular, example methods may provide for operating a device in a multi-device environment, directing the presentation, on a display of the device, of a first image, detecting a motion of the device, directing a change of the image presented on the display of the device from the first image to a second image in response to detecting the motion of the device. The first image presented on the device is related to images displayed on other devices in the multi-device environment. The second image may be a scaled version of the first image and the second image may be scaled based on at least one property of the motion. Each device in the multi-device environment may be directed to display a portion of a complete image, where the first image is a portion of the complete image.

### FIELD OF INVENTION

Example embodiments of the present invention relate generally to displays and user interfaces of mobile devices and, in particular, to controlling the level of information detail displayed on the display of a device when used in a multi-device environment.

### BACKGROUND

The modern communications era has brought about a tremendous expansion of wireline and wireless networks. Computer networks, television networks, and telephone networks are experiencing an unprecedented technological expansion, fueled by consumer demand. Wireless and mobile networking technologies have addressed consumer demands while providing more flexibility and immediacy of information transfer.

Mobile devices, such as cellular telephones, have become smaller and lighter while also becoming more capable of performing tasks that far exceed a traditional voice call. Mobile devices are increasingly becoming small, portable computing devices that are capable of running a variety of applications and providing a user with a display on which they may watch video, view web pages, play interactive games, or read text. Devices are often small enough to fit into a pocket to achieve desired portability of these devices; however, as the capabilities of the devices increases, the displays of such devices are used to display large amounts of information and view objects which have traditionally been displayed on larger, less portable displays. It may be desirable to provide a method of enhancing the displayed information of a single device in a multi-device environment in response to a user input.

### BRIEF SUMMARY

In general, exemplary embodiments of the present invention provide an improved method of enhancing a user interface with a mobile device by joining the displays of multiple devices together to function together with one another and controlling information detail in a multi-device environment. In particular, the method of example embodiments provides for directing a presentation of a first image by a processor on a display of a device configured to operate in a multi-device environment, detecting a motion of the device, directing a change of an image presented on the display of the device from the first image to a second image in response to detecting the motion of the device. Where the first image presented on the device is related to images presented on other devices in the multi-device environment. The second image may be a scaled version of the first image and the method may further include scaling the second image based on at least one property of the motion. Each device in the multi-device environment may be directed to present a portion of a complete image, and the first image may be a portion of the complete image. The method may further entail directing at least one other device in the multi-device environment to change an image presented on the display of the at least one other device in response to the detected motion of the device. The motion of the device may include moving the device from a first location and the method may further include again directing presentation of the first image on the device in response to detection that the device being returned to the first location. The second image may be an expanded view of the first image including information not present in the first image.

According to another embodiment of the present invention, an apparatus is provided. The apparatus may include at least one processor and at least one memory including computer program code, the at least one processor and the at least one memory including computer program code. The at least one memory and the computer program code may be configured to, with the at least one processor, cause the apparatus to at least direct presentation of a first image on a display of a device configured to operate in a multi-device environment, detect a motion of the device, and direct a change of an image presented on the display of the device from the first image to a second image in response to detecting the motion of the device. The first image presented on the device may be related to images presented on other devices in the multi-device environment. The second image may be a scaled version of the first image and the computer program code may be further configured to cause the apparatus to scale the second image based on at least one property of the motion. The memory and the computer program code may be configured to, with the at least one processor, cause the apparatus to present a portion of a complete image, and the first image is a portion of the complete image. The at least one memory and the computer program code may be configured to, with the at least one processor, cause the apparatus to direct at least one other device in the multi-device environment to change an image presented on the display of the at least one other device in response the detected motion of the device. The motion of the device may include moving the device from a first location and the apparatus may be further caused to again direct presentation of the first image on the device in response to detection that the device has returned to the first location. The second image may be an expanded view of the first image presenting information not present in the first image.

A further embodiment of the invention may include a computer program product including at least one computer-readable storage medium having computer-executable program code instructions stored therein, the computer-executable program code instructions may include program code instructions for directing the presentation of a first image on a display of a device configured to operate in a multi-device environment, program code instructions for detecting a motion of the device, and program code instructions for directing a change of an image presented on the display of the device from the first image to a second image in response to detecting the motion of the device. The first image presented on the device may be related to images presented on other devices in the multi-device environment. The second image may be a scaled version of the first image and the computer program product may further include program code instructions for scaling the second image based on at least one property of the motion. The computer program product may further include program code instructions to cause each device in the multi-device environment to present a portion of a complete image, and the first image may be a portion of a complete image. The computer program product may further include program code instructions for causing at least one other device in the multi-device environment to change an image presented on the display of said at least one other device in response to the detected motion of the device. The motion of the device may include moving the device from a first location and the computer program product may further include program code instructions for again directing presentation of the first image on the device in response to the device being returned to the first location.

Another example embodiment of the present invention may provide a means for directing presentation of a first image on a display of a device configured to operate in a multi-device environment, means for detecting a motion of the device, and means for directing a change of the image presented on the display of the device from the first image to a second image in response to detecting the motion of the device. The first image presented on the device may be related to images presented on other devices in the multi-device environment. The second image may be a scaled version of the first image and the apparatus may include means for scaling the second image based on at least one property of the motion. The apparatus may further include means for presenting a portion of a complete image, where the first image is a portion of the complete image. The apparatus may include means for directing at least one other device in the multi-device environment to change an image presented on the display of the at least one other device in response the detected motion of the device. The motion of the device may include moving the device from a first location and the apparatus may include means again directing presentation of the first image on the device in response to detection that the device has returned to the first location. The second image may be an expanded view of the first image presenting information not present in the first image.

In general, further example embodiments of the present invention may provide a simple and intuitive method for combining the displays of multiple devices in a multi-device environment and for indicating the spatial arrangement of the devices relative to one another. The method may include detecting a touch, receiving an indication of a touch on another device in a multi-device environment, obtaining an order of devices in the multi-device environment, and providing for operation according to the order of devices. The method may further include obtaining a location relative to another device in the multi-device environment in response to receiving an indication of a touch on said device. The method may also include providing for display of a portion of an image based upon the location relative to another device. Receiving an indication of a touch on another device in a multi-device environment may include receiving a request to join said device in the multi-device environment.

According to another embodiment of the present invention, an apparatus is provided. The apparatus may include at least one processor and at least one memory including computer program code, the at least one processor and the at least one memory including computer program code. The at least one memory and the computer program code may be configured to, with the at least one processor, cause the apparatus to at least detect a touch, receive an indication of a touch on another device in a multi-device environment, obtain an order of devices in the multi-device environment, and provide for operation according to the order of devices. The apparatus may further be caused to obtain a location relative to another device in the multi-device environment in response to receiving an indication of a touch on said device and provide for display of a portion of an image based upon the location relative to another device. Receiving an indication of a touch on another device in the multi-device environment may include receiving a request to join the device in the multi-device environment.

A further embodiment of the invention may include a computer program product including at least one computer-readable storage medium having computer-executable program code instructions stored therein, the computer-executable program code instructions may include program code instructions for detecting a touch, program code instructions for receiving an indication of a touch on another device in a multi-device environment, program code instructions for obtaining an order of devices in the multi-device environment, and program code instructions for providing for operation according to the order of devices. The computer program product may further include program code instructions for obtaining a location relative to another device in the multi-device environment in response to receiving an indication of a touch on the device and program code instructions for providing for display of a portion of an image based upon the location relative to another device. The program code instructions for receiving an indication of a touch on another device in a multi-device environment may include program code instructions for receiving a request to join the device in the multi-device environment.

Another example embodiment of the present invention may provide an apparatus including means for detecting a touch, means for receiving an indication of a touch on another device in a multi-device environment, means for obtaining an order of devices in the multi-device environment, and means for providing for operation according to the order of devices. The apparatus may further include means for obtaining a location relative to another device in the multi-device environment in response to receiving an indication of a touch on the device and means for providing for display of a portion of an image based upon the location relative to another device. Receiving an indication of a touch on another device in a multi-device environment may include receiving a request to join the device in the multi-device environment.

### BRIEF DESCRIPTION OF THE DRAWING(S)

Having thus described the invention in general terms, reference will now be made to the accompanying drawings, which are not necessarily drawn to scale, and wherein:

FIG. 1 illustrates an communication system in accordance with an example embodiment of the present invention;

FIG. 2 is a schematic block diagram of a mobile device according to an example embodiment of the present invention;

FIG. 3 illustrates an example embodiment of an image presented in a multi-device environment;

FIG. 4 depicts an example embodiment of mobile terminal controlling information detail in a multi-device environment;

FIG. 5 depicts another example embodiment of mobile terminal controlling information detail in a multi-device environment;

FIG. 6 depicts another example embodiment of an image presented in a multi-device environment;

FIG. 7 depicts an another example embodiment of mobile terminal controlling information detail in a multi-device environment;

FIG. 8 illustrates an example embodiment of an image presented in a multi-device environment;

FIG. 9 depicts another example embodiment of a mobile terminal controlling information detail in a multi-device environment;

FIG. 10 illustrates an example embodiment of a mind map presented in a multi-device environment;

FIG. 11 depicts an example embodiment of a mobile terminal controlling the information detail of a mind map in a multi-device environment as an example of hierarchical data objects that may be expanded and collapsed;

FIG. 12 illustrates an example embodiment of a touch gesture for combining the displays of multiple mobile terminals in a multi-device environment according to the present invention;

FIG. 13 illustrates another example embodiment of a touch gesture for combining the displays of mobile terminals in a multi-device environment according to the present invention;

FIG. 14 is a flowchart of a method of controlling information detail in a multi-device environment according to an example embodiment of the present invention; and

FIG. 15 is a flowchart of a method of combining the displays of multiple mobile terminals in a multi-device environment according to an example embodiment of the present invention.

### DETAILED DESCRIPTION

Some example embodiments of the present invention will now be described more fully hereinafter with reference to the accompanying drawings, in which some, but not all embodiments of the invention are shown. Indeed, various embodiments of the invention may be embodied in many different forms and should not be construed as limited to the example embodiments set forth herein; rather, these example embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

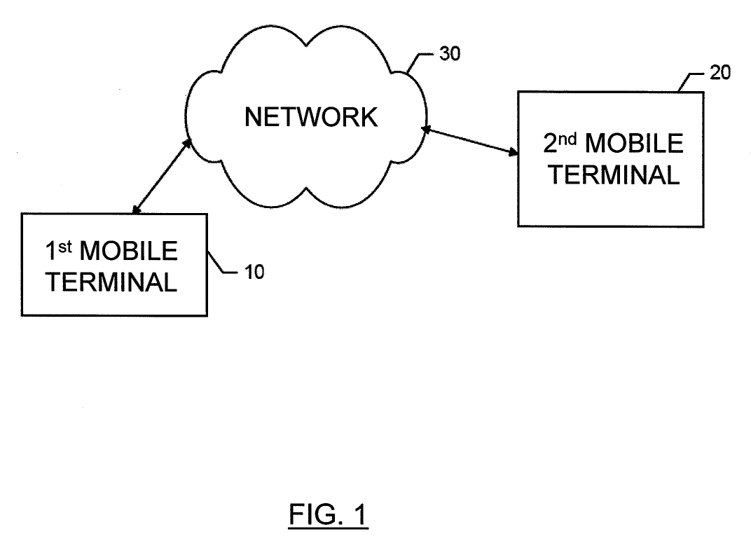

A session may be supported by a network 30 as shown in FIG. 1 that may include a collection of various different nodes, devices or functions that may be in communication with each other via corresponding wired and/or wireless interfaces or in ad-hoc networks such as those functioning over Bluetooth®. As such, FIG. 1 should be understood to be an example of a broad view of certain elements of a system that may incorporate example embodiments of the present invention and not an all inclusive or detailed view of the system or the network 30. Although not necessary, in some example embodiments, the network 30 may be capable of supporting communication in accordance with any one or more of a number of first-generation (1G), second-generation (2.G), 2.5G, third-generation (3G), 3.5G, 3.9G, fourth-generation (4G) mobile communication protocols and/or the like.

One or more communication terminals such as the mobile terminal 10 and the second mobile terminal 20 may be in communication with each other via the network 30 and each may include an antenna or antennas for transmitting signals to and for receiving signals from a base site, which could be, for example a base station that is part of one or more cellular or mobile networks or an access point that may be coupled to a data network, such as a local area network (LAN), a metropolitan area network (MAN), and/or a wide area network (WAN), such as the Internet. In turn, other devices (e.g., personal computers, server computers or the like) may be coupled to the mobile terminal 10 and the second mobile terminal 20 via the network 30. By directly or indirectly connecting the mobile terminal 10 and the second mobile terminal 20 and other devices to the network 30, the mobile terminal 10 and the second mobile terminal 20 may be enabled to communicate with the other devices or each other, for example, according to numerous communication protocols including Hypertext Transfer Protocol (HTTP) and/or the like, to thereby carry out various communication or other functions of the mobile terminal 10 and the second mobile terminal 20, respectively.

In example embodiments, either of the mobile terminals may be mobile or fixed communication devices. Thus, for example, the mobile terminal 10 and the second mobile terminal 20 could be, or be substituted by, any of personal computers (PCs), personal digital assistants (PDAs), wireless telephones, desktop computer, laptop computer, mobile computers, cameras, video recorders, audio/video players, positioning devices, game devices, television devices, radio devices, or various other devices or combinations thereof.

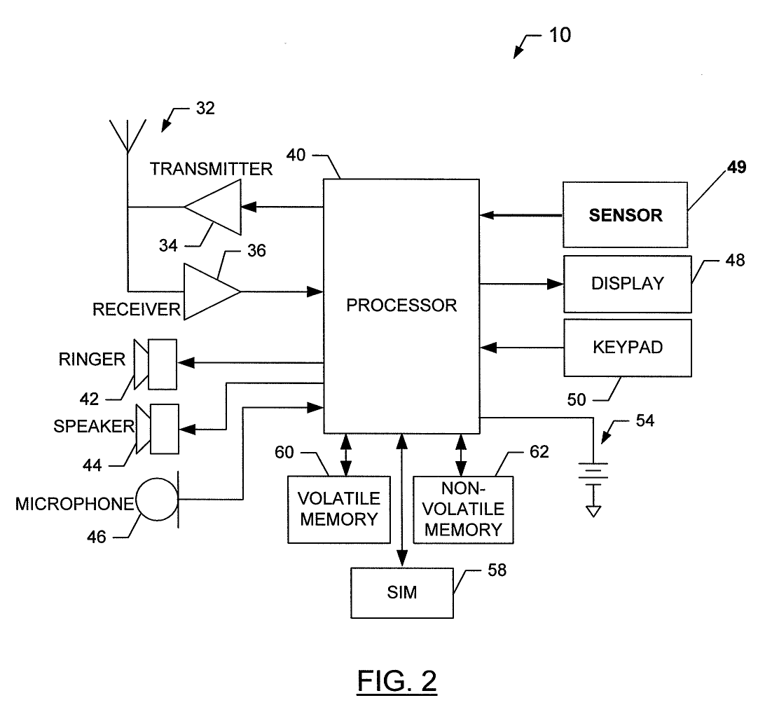

Although the mobile terminal 10 may be configured in various manners, one example of a mobile terminal that could benefit from embodiments of the invention is depicted in the block diagram of FIG. 2. While several embodiments of the mobile terminal may be illustrated and hereinafter described for purposes of example, other types of mobile terminals, such as portable digital assistants (PDAs), pagers, mobile televisions, gaming devices, all types of computers (e.g., laptops or mobile computers), cameras, audio/video players, radio, global positioning system (GPS) devices, or any combination of the aforementioned, and other types of communication devices, may employ embodiments of the present invention. As described, the mobile terminal may include various means for performing one or more functions in accordance with embodiments of the present invention, including those more particularly shown and described herein. It should be understood, however, that a mobile terminal may include alternative means for performing one or more like functions, without departing from the spirit and scope of the present invention.

The mobile terminal (e.g., mobile terminal 10) may, in some embodiments, be a computing device configured to employ an example embodiment of the present invention. However, in some embodiments, the mobile terminal may be embodied as a chip or chip set. In other words, the mobile terminal may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The mobile terminal may therefore, in some cases, be configured to implement an embodiment of the present invention on a single chip or as a single “system on a chip.” As such, in some cases, a chip or chipset may constitute means for performing one or more operations for providing the functionalities described herein.

The mobile terminal 10 illustrated in FIG. 2 may include an antenna 32 (or multiple antennas) in operable communication with a transmitter 34 and a receiver 36. The mobile terminal may further include an apparatus, such as a processor 40, that provides signals to and receives signals from the transmitter and receiver, respectively. The signals may include signaling information in accordance with the air interface standard of the applicable cellular system, and/or may also include data corresponding to user speech, received data and/or user generated data. In this regard, the mobile terminal may be capable of operating with one or more air interface standards, communication protocols, modulation types, and access types. By way of illustration, the mobile terminal may be capable of operating in accordance with any of a number of first, second, third and/or fourth-generation communication protocols or the like. For example, the mobile terminal may be capable of operating in accordance with second-generation (2G) wireless communication protocols IS-136, GSM and IS-95, or with third-generation (3G) wireless communication protocols, such as UMTS, CDMA2000, wideband CDMA (WCDMA) and time division-synchronous CDMA (TD-SCDMA), with 3.9G wireless communication protocols such as E-UTRAN (evolved—UMTS terrestrial radio access network), with fourth-generation (4G) wireless communication protocols or the like.

It is understood that the apparatus, such as the processor 40, may include circuitry implementing, among others, audio and logic functions of the mobile terminal 10. The processor may be embodied in a number of different ways. For example, the processor may be embodied as various processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like), a hardware accelerator, and/or the like.

In an example embodiment, the processor 40 may be configured to execute instructions stored in the memory device 60 or otherwise accessible to the processor 40. Alternatively or additionally, the processor 40 may be configured to execute hard coded functionality. As such, whether configured by hardware or software methods, or by a combination thereof, the processor 40 may represent an entity (e.g., physically embodied in circuitry) capable of performing operations according to an embodiment of the present invention while configured accordingly. Thus, for example, when the processor 40 is embodied as an ASIC, FPGA or the like, the processor 40 may be specifically configured hardware for conducting the operations described herein. Alternatively, as another example, when the processor 40 is embodied as an executor of software instructions, the instructions may specifically configure the processor 40 to perform the algorithms and/or operations described herein when the instructions are executed. However, in some cases, the processor 40 may be a processor of a specific device (e.g., a mobile terminal or network device) adapted for employing an embodiment of the present invention by further configuration of the processor 40 by instructions for performing the algorithms and/or operations described herein. The processor 40 may include, among other things, a clock, an arithmetic logic unit (ALU) and logic gates configured to support operation of the processor 40.

The mobile terminal 10 may also comprise a user interface including an output device such as an earphone or speaker 44, a ringer 42, a microphone 46, a display 48, and a user input interface, which may be coupled to the processor 40. The user input interface, which allows the mobile terminal to receive data, may include any of a number of devices allowing the mobile terminal to receive data, such as a keypad 50, a touch sensitive display (not shown) or other input device. In embodiments including the keypad, the keypad may include numeric (0-9) and related keys (#, *), and other hard and soft keys used for operating the mobile terminal 10. Alternatively, the keypad may include a conventional QWERTY keypad arrangement. The keypad may also include various soft keys with associated functions. In addition, or alternatively, the mobile terminal may include an interface device such as a joystick or other user input interface. The mobile terminal may further include a battery 54, such as a vibrating battery pack, for powering various circuits that are used to operate the mobile terminal, as well as optionally providing mechanical vibration as a detectable output. The mobile terminal 10 may also include a sensor 49, such as an accelerometer, motion sensor/detector, temperature sensor, or other environmental sensor to provide input to the processor indicative of a condition or stimulus of the mobile terminal 10.

The mobile terminal 10 may further include a user identity module (UIM) 58, which may generically be referred to as a smart card. The UIM may be a memory device having a processor built in. The UIM may include, for example, a subscriber identity module (SIM), a universal integrated circuit card (UICC), a universal subscriber identity module (USIM), a removable user identity module (R-UIM), or any other smart card. The UIM may store information elements related to a mobile subscriber. In addition to the UIM, the mobile terminal may be equipped with memory. For example, the mobile terminal may include volatile memory 60, such as volatile Random Access Memory (RAM) including a cache area for the temporary storage of data. The mobile terminal may also include other non-volatile memory 62, which may be embedded and/or may be removable. The non-volatile memory may additionally or alternatively comprise an electrically erasable programmable read only memory (EEPROM), flash memory or the like. The memories may store any of a number of pieces of information, and data, used by the mobile terminal to implement the functions of the mobile terminal. For example, the memories may include an identifier, such as an international mobile equipment identification (IMEI) code, capable of uniquely identifying the mobile terminal. Furthermore, the memories may store instructions for determining cell id information. Specifically, the memories may store an application program for execution by the processor 40, which determines an identity of the current cell, i.e., cell id identity or cell id information, with which the mobile terminal is in communication.

In general, example embodiments of the present invention provide a method for controlling information detail depicted on the display of a device, such as a mobile terminal 10. In particular, embodiments may control information detail depicted on the display of a mobile terminal relative to at least one other mobile terminal when the mobile terminal is operating in a multi-device environment. For example a first mobile terminal may be operating in a near-field network with at least one other mobile terminal, through a protocol such as Bluetooth™, and the mobile terminals may be operating in a symbiotic manner in which the displays of the mobile terminals are joined together to create a larger display capable of presenting a greater amount of detail of an image, document, or other object presented across the displays of the mobile terminals. While the term “image” is used herein to describe what is presented on the display of a mobile terminal, it is to be understood that the term image is not limited to media files or images in the conventional sense, but rather the presentation of any object of data, media, or otherwise which may be presented on the display of a mobile terminal.

An example application for which embodiments of the present invention may be implemented includes a virtual mind map as presented on a first mobile terminal placed, for example, on a table top surface. A second mobile terminal may be placed adjacent to the first mobile terminal and a join-event may occur to join the two devices in a multi-device environment. The join event may include a touch gesture between the two mobile terminals or a menu-driven pairing operation operable on either or both mobile terminals. Mobile terminals that have previously been joined in a multi-device environment may require only to be placed directly adjacent one another to initiate the join event. The user(s) may indicate through a gesture or a menu prompt by either terminal that a join event is to occur or to simply confirm the join event. Once joined, the two mobile terminals may function cooperatively (or independently) in dependence of the application executed on one or both of the mobile terminals. For example, in the case of a virtual mind map, the second terminal may present a portion of the virtual mind map that was previously off-screen of the first mobile terminal as the second mobile terminal may function to expand the display area of the first mobile terminal.

A multi-device near-field network may provide a multi-device environment in which multiple mobile terminals may be used cooperatively to enhance a user experience. Mobile terminals may be “joined” to the network through a number of possible manners, such as through motion gestures of adjacent mobile terminals, or through a manual connection procedure in which a user synchronizes or pairs a mobile terminal with another mobile terminal. The motion gesture for joining the devices may consist of a sequence of primitive discrete gestures like taps on each device, or it may be a continuous gesture (e.g. of circular shape) that spans across the displays of the devices. In one embodiment of the present invention, the order of the devices in the group may be defined through the order each device is joined to the group through the motion gesture. For example, the device that is tapped first or is the starting point for a continuous joining gesture, becomes the first or “dominant” device in the group. In yet another embodiment, the devices are able to track each others' relative position (e.g. the devices form a circle), the joining gesture may be started by a user (e.g. by tapping on three adjacent devices in clockwise direction) and the rest of the devices and their order in the group may be determined automatically (e.g. adding each adjacent device to the group following the clockwise order). Once joined, two or more mobile terminals may cooperatively perform actions or execute programs to enhance a user experience. The methods of cooperation may differ depending upon the application or functions being performed by the mobile terminals. The applications may utilize the order of the devices in the group to determine which information to present or to relay between the users. Such applications that consider the order of the devices in a group include various games, educational applications, expert review systems like medical applications, enterprise applications like auditing, and so forth.

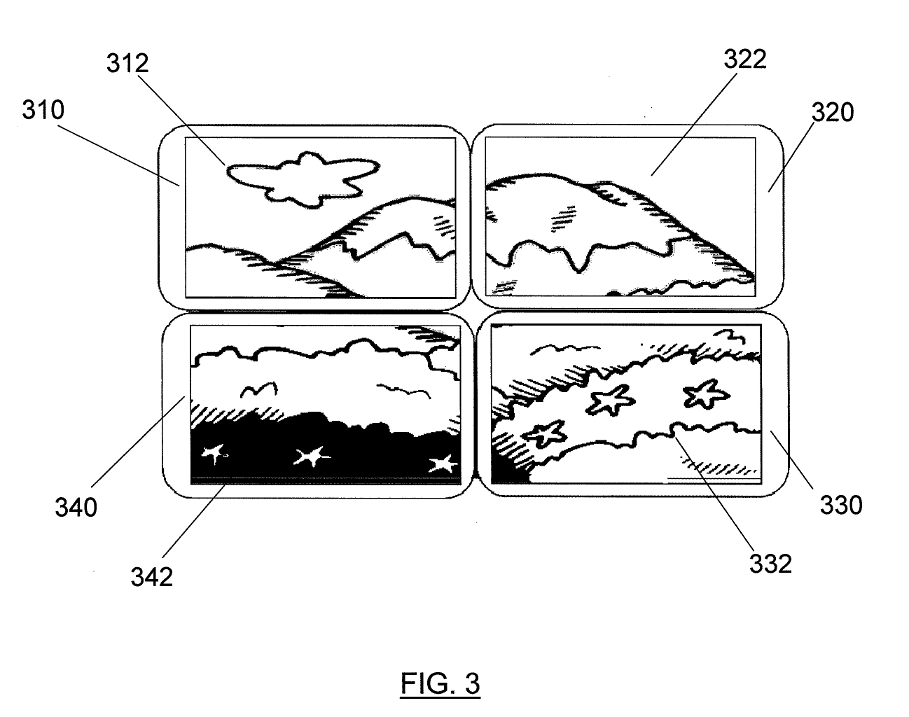

One example of cooperation may include a media viewing application in which the displays of at least two mobile terminals are virtually joined to create a larger display as illustrated in FIG. 3 which depicts four mobile terminals situated on a substantially co-planar surface. One mobile terminal 310 with a display 312 that includes a resolution of 640 pixels by 360 pixels may be virtually joined with the displays (322, 332, 342) of three other mobile terminals (320, 330, 340) to create a display with an effective size of 1280 pixels by 720 pixels. Each of the four mobile terminals (310, 320, 330, 340) presents on the display a portion of a single image or media file, thereby increasing the information detail visible to a user. The mobile terminals 310-340 may be configured to recognize their location relative to the other mobile terminals through the near-field communication or by sensors, such as sensor 49 of FIG. 2, disposed about the periphery of the mobile terminal. The first mobile terminal 310 may recognize that it is in a multi-device environment with three other mobile terminals, and their relative locations are configured with one at each corner. The first mobile terminal 310 may further recognize through one or more sensors that the first mobile terminal 310 is disposed in the top, left corner, thus the image presented on the display 312 of the first mobile terminal 310 may be the top left corner of the image. Such a multi-device environment may be expanded to include any number of mobile terminals, with each additional mobile terminal offering a larger viewable area to be presented.

While FIG. 3 illustrates an image as viewed by the joined mobile terminals of a multi-device environment, the multiple mobile terminals may be capable of cooperating to perform other functions. For example, the mobile terminals 310-340 may cooperate to present a spreadsheet whereby the spreadsheet is rendered larger and more readable when presented across the virtual display created by the joined mobile terminals. Further, the displays of each mobile terminal may provide different functions within an application or different images from an application. One such example may include wherein one or more mobile terminals are presenting an overview of a map while another mobile terminal is presenting the legend of said map.

Example embodiments of the present invention are described herein with reference to a mobile terminal comprising a touch-sensitive display (e.g., a touchscreen); however, embodiments of the present invention may be configured to be operable on various types of mobile terminals with single or multi-touch displays, displays with separate touch-pad user-interfaces, or other display types.

Embodiments of the present invention may comprise at least two fundamental operations. A first operation includes a mobile terminal being joined with at least one other mobile terminal to form a multi-device environment. The multi-device environment may be supported, for example, by a near-field communications protocol such as Bluetooth™. Once joined, the mobile terminals of the multi-device environment may be configured to control the level of information detail depicted on each of the mobile terminals in the multi-device environment. The second operation includes enabling functionality of at least one of the mobile terminals to control the information detail of at least one of the mobile terminals in the multi-device environment. A first mobile terminal of the mobile terminals of the multi-device environment may control the information detail level for the first mobile terminal and the first mobile terminal may also control the information detail level of each of the remaining mobile terminals in the multi-device environment.

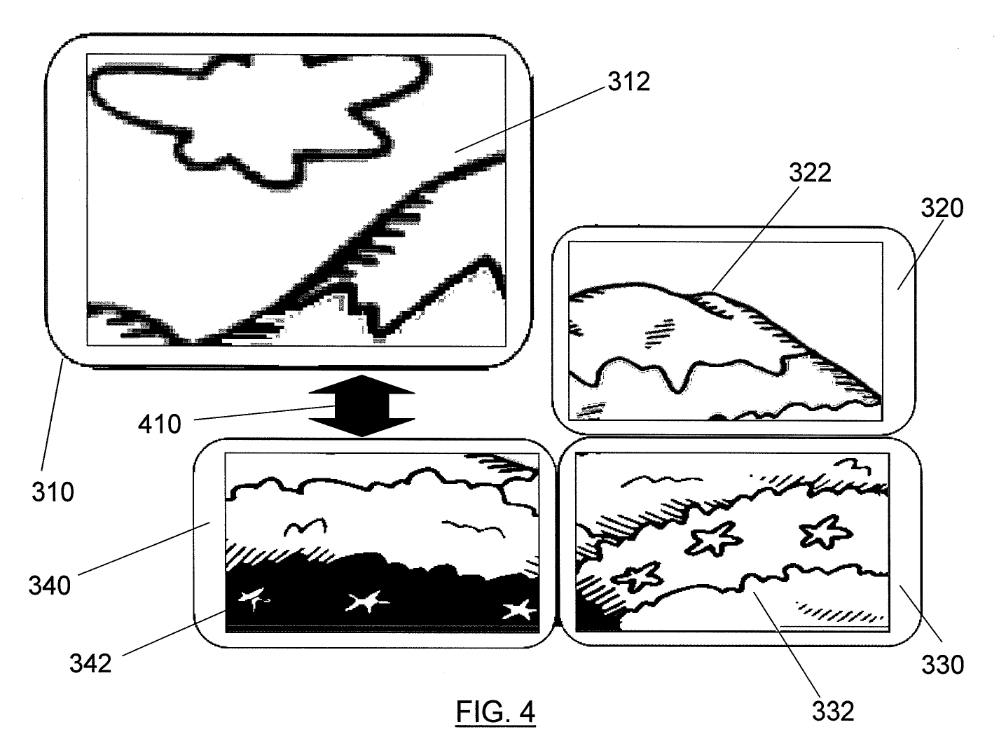

An example embodiment of the present invention is illustrated in FIG. 4 which depicts the multi-device environment of FIG. 3 with the first mobile terminal 310 operable to control the information detail level depicted on the display 312 of the first mobile terminal 310. As illustrated, the first mobile terminal 310 has been elevated or raised off of the substantially coplanar surface on which the remaining mobile terminals 320, 330, and 340 are situated, along arrow 410 (e.g., in the direction perpendicular to the plane of the figure). The motion of the first mobile terminal 310 may be recognized by an accelerometer (such as sensor 49) or other sensor. Optionally, the multi-device environment may be able to detect and determine the location of each mobile terminal relative to one another through various sensors or radio-frequency locating. In response to the motion of the first mobile terminal 310 “up” from the substantially coplanar surface (or the locational change as determined by the multi-device environment), the presented image may be altered accordingly. In the illustrated embodiment, the image presented on the display 312 of the first mobile terminal 310 is “zoomed in” or the scale of the image is changed (e.g. magnified) in response to the motion detected. The level of zoom or magnification (e.g., 1.5 times the original size or ten times the original size) may be dependent upon a dynamic property of the motion of the first mobile terminal 310, such as the speed at which the motion occurred or the degree to which the first mobile terminal 310 was elevated away from the substantially coplanar surface on which the other mobile terminals 320, 330, 340 are situated. For example, a rapid motion may cause a large factor of zoom (e.g., five times original size) whereas a slow motion may cause a smaller factor of zoom (e.g., two times the original size). The level of position change may also influence the zoom-factor. For example, raising the first mobile terminal 310 six inches from the surface may result in a zoom factor of two times the original size whereas raising the mobile terminal 310 twenty inches from the surface may result in a zoom factor of ten times the original size. Returning the first mobile terminal 310 to the substantially coplanar surface may restore the image to the originally scaled size, or a zoom factor of one.

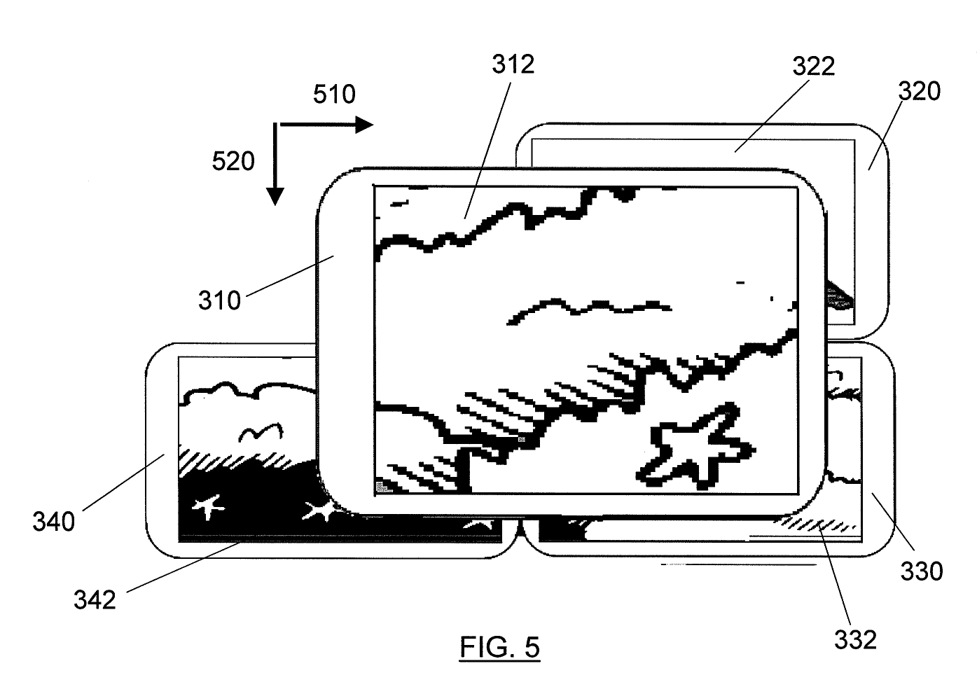

Another example embodiment of the present invention is illustrated in FIG. 5 which depicts the multi-device environment of FIG. 4, with the first mobile terminal 310 operable to control the information detail level depicted on the display of the first mobile terminal 310. The illustrated example depicts the functionality illustrated in FIG. 4 of the first mobile terminal depicting a zoomed-in portion of the image on the display 312 of the first mobile terminal 310; however, in the embodiment of FIG. 5, the first mobile terminal has further been moved laterally relative to the other mobile terminals 320, 330, 340. The lateral motion of the mobile terminal along arrows 510, 520 may be determined by the mobile terminal 310 in the same manner that the initial motion along arrow 410 was detected. An accelerometer such as sensor 49 may determine the motion and translate the motion into an electrical signal used by the processor to interpret the motion, or the multi-device environment may determine the location change of the first mobile terminal 310 relative to the other mobile terminals 320, 330, 340. The motion along arrows 510 and 520 may be interpreted as a panning motion to pan around the image depicted on the displays 312, 322, 332, 342 of the mobile terminals 310, 320, 330, 340. In the illustrated embodiment of FIG. 5, the image presented on the display 312 of the first mobile terminal 310 may include a portion of the image not previously presented on the first mobile terminal 310. The depicted image includes at least a portion of the image previously depicted on the display 332 of another mobile terminal 330. In the depicted embodiments of FIGS. 4 and 5, the images presented on the displays 322, 332, and 342 of the respective mobile terminals 320, 330, and 340 remain unchanged in response to the motion of the first mobile terminal 310; however, the images of the mobile terminals that are not being moved may be responsive to the motion of the first mobile terminal 310 as described further below. Returning the first mobile terminal 310 to the original location relative to the other mobile terminals 320, 330, and 340, may restore the image to the originally presented image as depicted in FIG. 3.

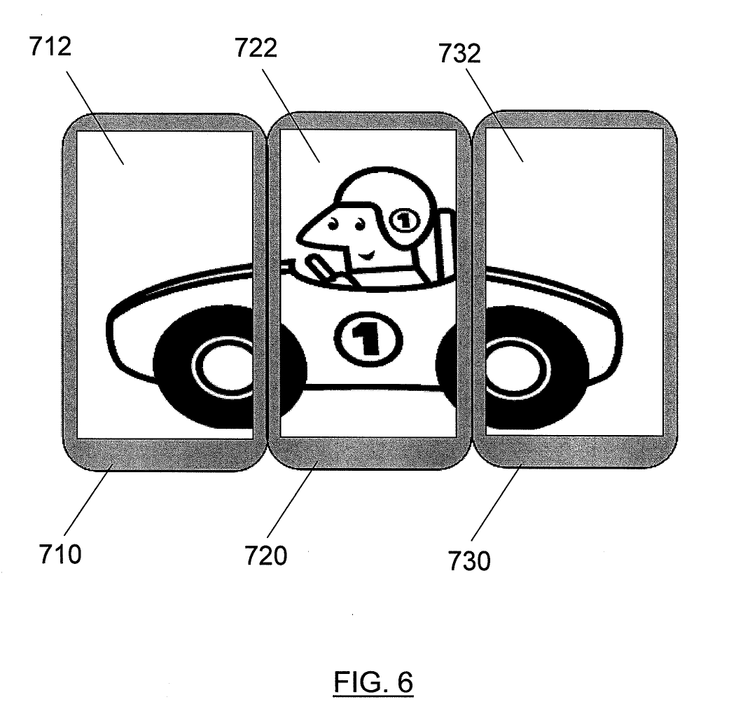

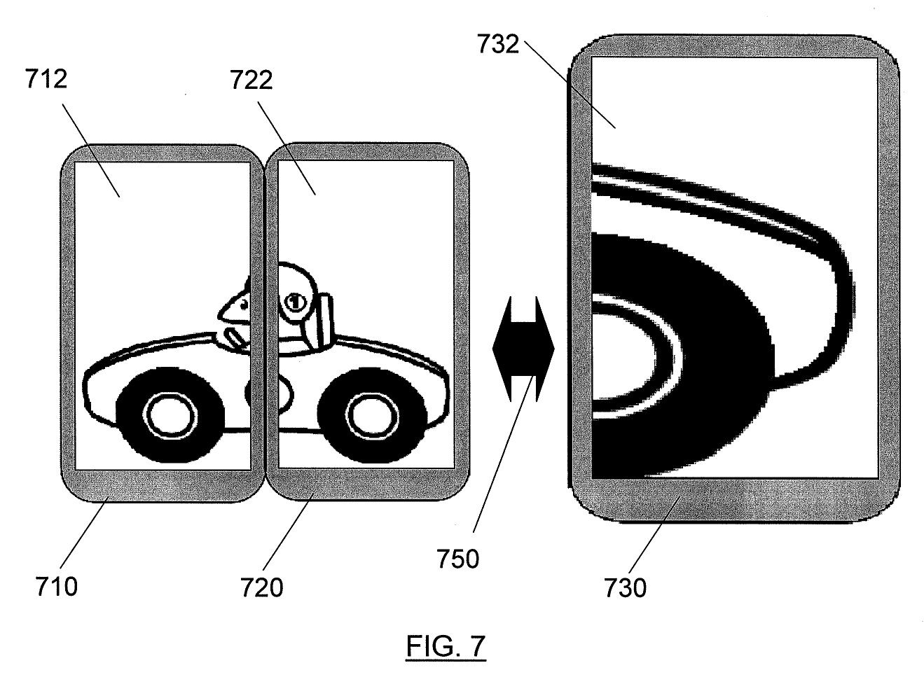

FIG. 6 illustrates an example embodiment of a multi-device environment including three mobile terminals 710, 720, 730, arranged side-by-side on a substantially coplanar surface. The displays 712, 722, 732 of the mobile terminals each present a portion of an image. The image is rendered across all three displays 712, 722, and 732 creating a larger display than available on a single mobile terminal. FIG. 7 depicts the third mobile terminal 730 as raised from the substantially coplanar surface along arrow 750, in a direction substantially perpendicular to the figure. While the image presented on the display 732 of the third mobile terminal 730 becomes a zoomed-in version of the original image, the mobile terminals 710, 720 remaining on the substantially coplanar surface are changed to reflect the removal of the third mobile terminal 730 from the surface. In the illustrated embodiment, the image is redistributed across the mobile terminals 710, 720 remaining on the surface. Thus, the mobile terminals 710, 720, while not having been moved, reflect a change in the presented image in response to the third mobile terminal 730 being moved.

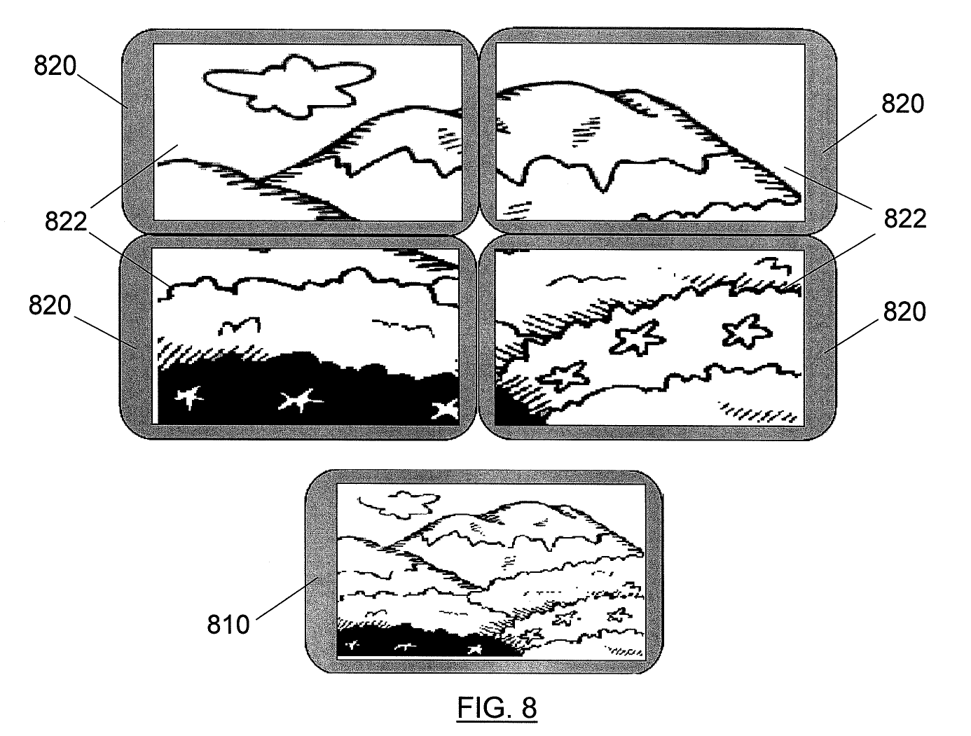

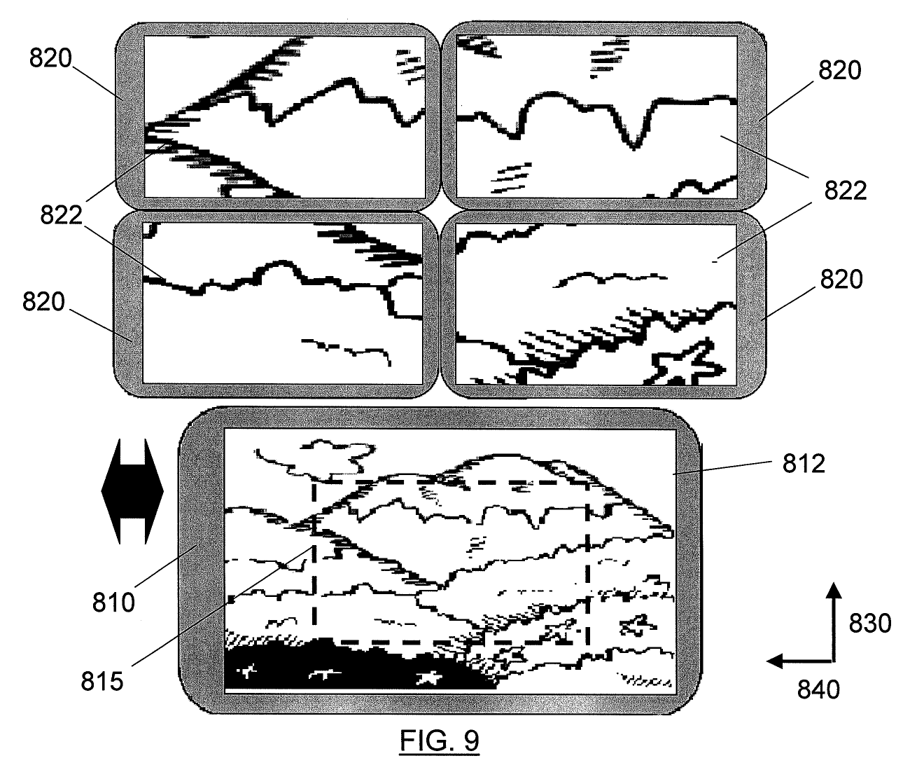

FIG. 8 illustrates another example embodiment of the present invention with a mobile terminal 810 operational in a multi-device environment consisting of the first mobile terminal 810 and four other mobile terminals 820 arranged in a tiled pattern. In the depicted embodiment, the first mobile terminal 810 shows on the display 812 the same image that is depicted on the four combined displays 822 of the other mobile terminals 820. In the illustrated embodiment, the first mobile terminal 810 may be resting on the same surface as the other mobile terminals 820, or optionally, the first mobile terminal 810 may be held by a user. FIG. 9 illustrates the first mobile terminal as moved in an upward direction either by a user raising the mobile terminal from the surface or simply elevating the first mobile terminal 810 from a previous location. The image presented on the display 812 of the first mobile terminal 810 may remain unchanged while the image presented across the joined displays of the other mobile terminals 820 in the multi-device environment may be responsive to the motion of the first mobile terminal 810 and may be cause to present a zoomed-in version of the previously presented image. Optionally, the first mobile terminal 810 may present the same zoomed-in image as presented across the joined displays 822 of the other mobile terminals 820. Further, the first mobile terminal may detect motion in a lateral plane, such as along arrows 830 and 840 which may effect a panning motion to pan around the image presented across the joined displays 822 of the other mobile terminals 820. The panning motion may or may not result in a panning of the image presented on the display 812 of the first mobile terminal 810. Optionally, an area 815 may be illustrated within the image presented on display 812 indicating the area of the original image which is currently presented across the displays 822 of the other mobile terminals 820.

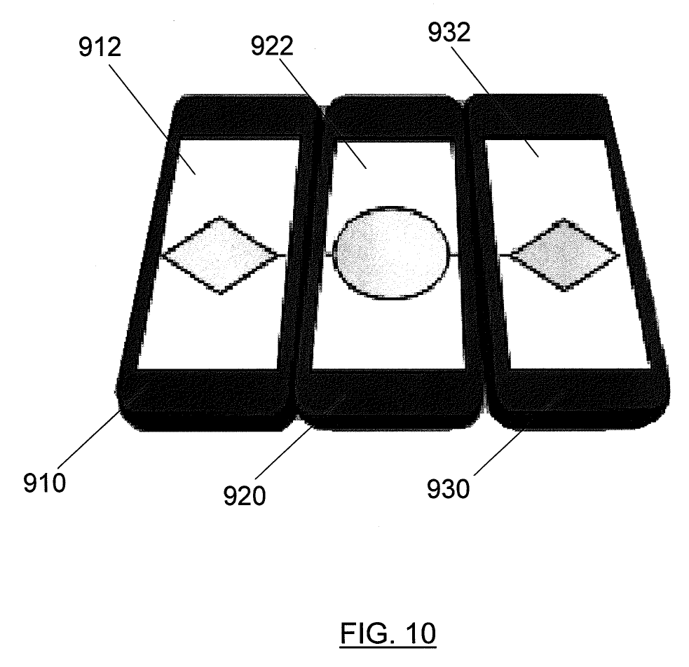

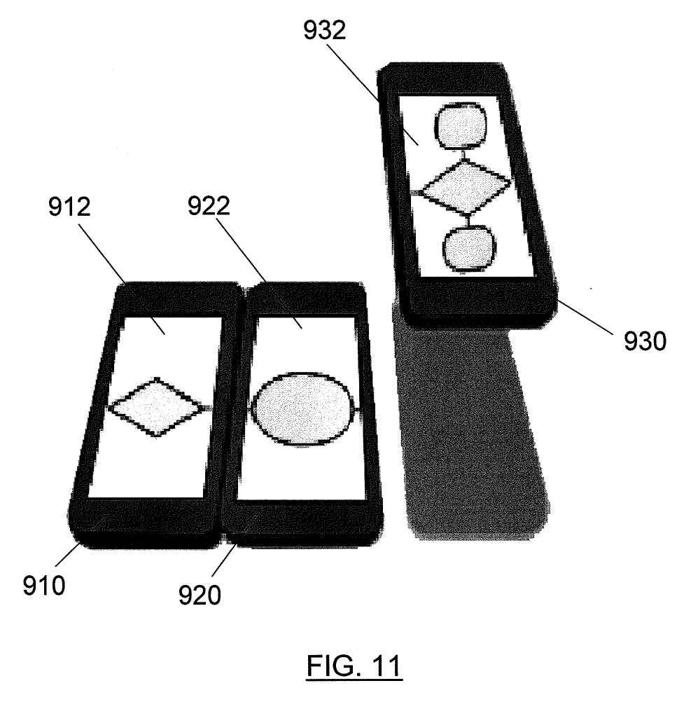

FIG. 10 illustrates a further implementation of example embodiments of the present invention in which a data object may be expanded in response to a user input motion to a mobile terminal. In the illustrated embodiment, three mobile terminals 910, 920, and 930 each present a data object on their respective displays 912, 922, 932. The data objects may contain more information than may be depicted on the displays of the mobile terminals such that interaction may be necessary to view all of the information available for any particular data object. FIG. 11 illustrates the third mobile terminal 930 in an elevated position relative to the other mobile terminals 910, 920. The motion of elevating the mobile terminal as detected by a sensor, such as an accelerometer, or the location determined by the multi-device environment, may cause the third mobile terminal 930 to present greater detail regarding the data object which had previously been shown on the display 932. This greater detail may be referred to as “semantic zoom” or “logical zoom” wherein the scale of the object may or may not be altered as with the scaled zooming of an image, but the level of detail shown may be increased. Such expanded detail may be useful in applications such as mind maps, presentation slides, text documents (e.g., in “outline view” in Microsoft Word®, games, and other applications that contain hierarchical data objects that may be expanded and collapsed. The image presented on the display 932 of the raised mobile terminal 930 of FIG. 11 shows an expanded view with more detail than that of the image presented on the display 932 of the mobile terminal 930 resting on the surface with the other mobile terminals 910, 920.

Example embodiments of the present invention may include a dominant mobile terminal which controls the images presented on each of the mobile terminals in the multi-device environment. The dominant mobile terminal may be determined at the time the multi-device environment is created. For example, when the multi-device environment is created through contact of the mobile terminals or through the pairing of mobile terminals, the first mobile terminal to initiate a join event with another mobile terminal may be considered the “dominant” mobile terminal and may then be the mobile terminal used to control the information detail depicted on the displays of each of the other mobile terminals. Alternatively, the dominant mobile terminal may be whichever mobile terminal in a multi-device environment experiences a stimulus that causes a change in the images presented on the displays of the other mobile terminals, such as any mobile terminal which is moved from its location within the multi-device environment. In an example embodiment where more than one mobile terminal is moved relative to the other mobile terminals in a multi-device environment, the first mobile terminal moved may remain the dominant mobile terminal or, optionally, the most recently moved mobile terminal may become the dominant mobile terminal. Each of these methods for determining the dominant mobile terminal in a multi-device environment may be user configurable by the mobile terminals in such a multi-device environment or the mobile terminals within a multi-device environment may be governed by a set of rules generated for a multi-device environment based upon the application used in the multi-device environment. For example, an image display application, when used in a multi-device environment, may include few, simple rules for determining the dominant mobile terminal, while a multi-device environment operating a spreadsheet program may have more complex rules requiring a single dominant mobile terminal to properly perform the spreadsheet application in the multi-device environment.

The joining of mobile terminals in a multi-device environment can be accomplished in a number of possible ways. Example embodiments of joining devices may include where mobile terminals are physically “bumped” together, where the “bump” is detected by, for example, microphones or accelerometers. Other methods for joining mobile terminals may include a pinch gesture across the displays of multiple mobile terminals. Further example embodiments may detect mobile terminals to be joined by RFID readers and tags, or infrared transmitters and receivers attached to the edges of a mobile terminal, for example. Optionally, more generic position tracking technologies may be used such as, for example ultrasound or radio technologies.

Determining the spatial arrangement of multiple mobile terminals in a multi-device environment may be accomplished via interpretation of a gesture or a touch of the display of a mobile terminal. For example, a continuous circle gesture performed across the displays of multiple mobile terminals may indicate the physical arrangement of the mobile terminals relative to one another and may further indicate the “dominant” mobile terminal based upon the starting location of the gesture. The motion of the gesture may connect the displays of the mobile terminal in the multi-device environment, set the physical arrangement of the mobile terminals relative to one another, and set the order of the mobile terminals in applications requiring turn-based access to content items (e.g., providing a hierarchy).

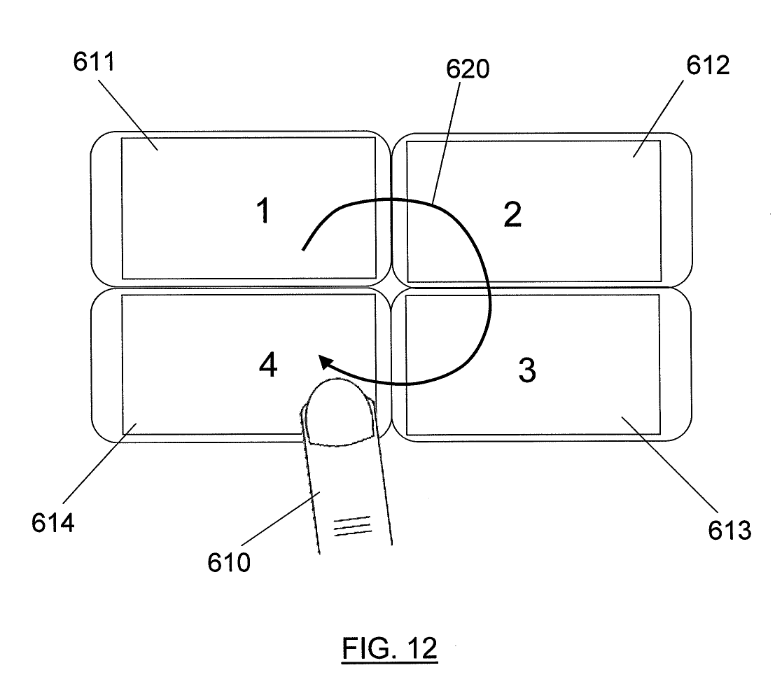

FIG. 12 depicts an example embodiment of a multi-device environment in which a finger 610 has made a circular gesture along arrow 620 across the displays of four mobile terminals. The illustrated gesture began at mobile terminal 611 and continued across the displays of mobile terminal 612 and 613 before ending at 614. In the illustrated embodiment, the device location and order of the mobile terminals may have been indicated by the gesture.

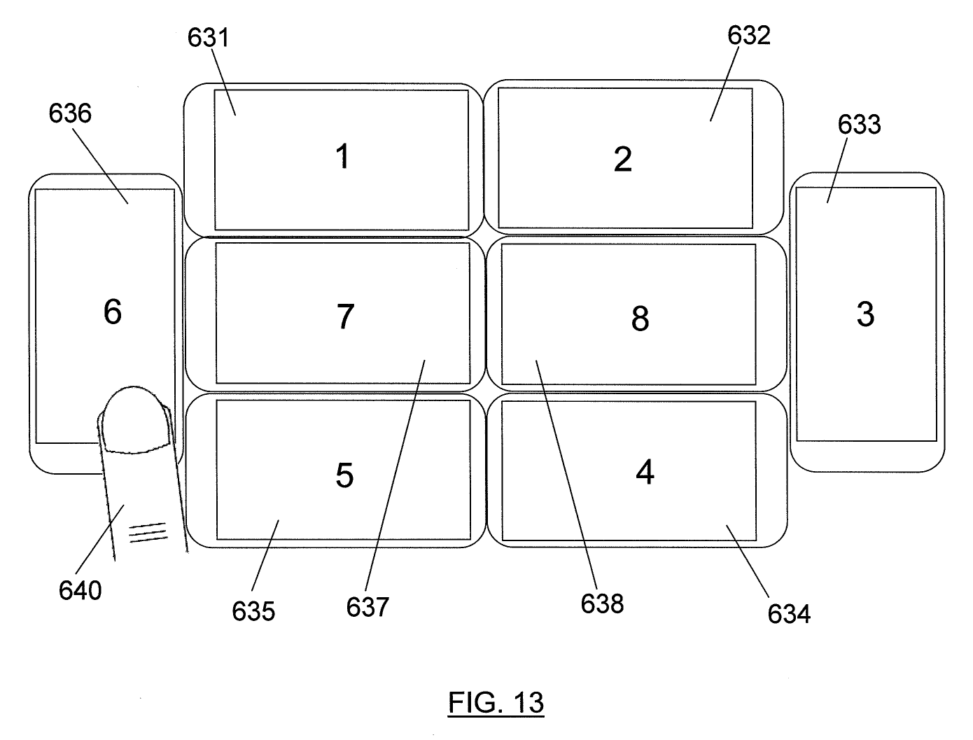

FIG. 13 illustrates another example embodiment of a multi-device environment in which a finger 640 has indicated an order of the mobile terminals by touching, in order, mobile terminals 631, 632, 633, 634, 635, and 636. The mobile terminals of FIG. 13 may include the ability to determine their locations relative to one another such that the touch of the mobile terminals serves to set the order of the devices rather than to determine physical location. Based upon the touch gestures of mobile terminals 631-636, mobile terminals 637 and 638 may recognize the clockwise circular motion and determine their order in the multi-device environment without requiring a touch gesture.

While the above example embodiments have been described with respect to a multi-device environment, further example embodiments of the present invention may be used with a single mobile terminal. For example, a mobile terminal may be on a surface or held by a user presenting an image on the display of the mobile terminal. In response to the mobile terminal being moved, for example, in an upward direction, the image presented on the mobile terminal may become zoomed-in. Further, the panning operation described above with respect to FIG. 5 may be operable when in the display of the mobile terminal is presenting the zoomed-in version of the image. Such an example may function in the same way as the first mobile terminal in the example described with respect to FIGS. 3-5; however, no additional mobile terminals may be necessary.

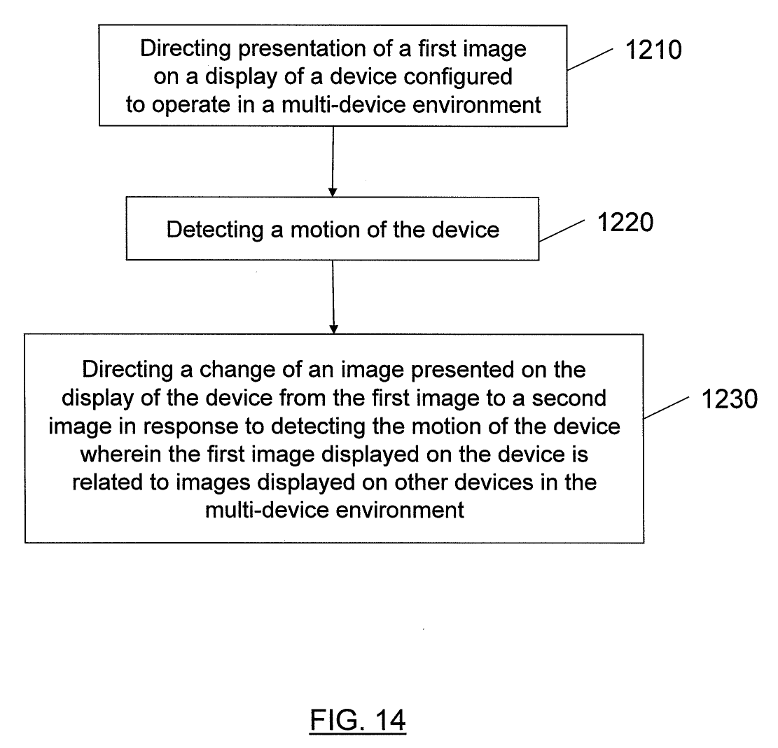

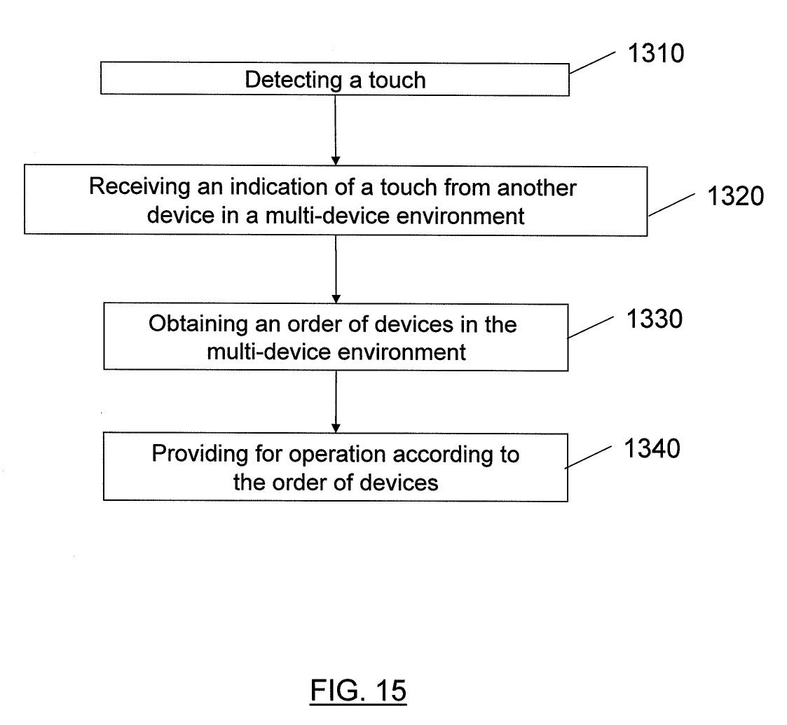

FIGS. 14 and 15 are flowcharts of systems, methods and program products according to example embodiments of the invention. The flowchart operations may be performed by a mobile terminal, such as shown in FIG. 2, as operating over a communications network such as that shown in FIG. 1. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware), such as depicted in FIG. 2, to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions, combinations of operations for performing the specified functions and program instruction means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

An example embodiment of a method of the present invention in which a device may control information detail in a multi-device environment is depicted in the flowchart of FIG. 14. A processor may direct presentation of a first image on a display of a device configured to operate in a multi-device environment at 1210. A motion of the device may be detected at 1220 by, for example, a sensor such as an accelerometer. A change of an image presented on the display may be directed from the first image to a second image in response to the detection of motion of the device at 1230. The first image displayed on the device may be related to images displayed on other devices in the multi-device environment.

Another example embodiment of a method of the present invention in which a simple and intuitive method for combining the displays of multiple mobile terminals in a multi-device environment, and for indicating the spatial arrangement of the mobile terminals relative to one another, is depicted in the flowchart of FIG. 15. A touch may be detected at 1310. The touch may be a drag, a tap, or a combination thereof. An indication of a touch from another device in a multi-device environment may be received at 1320. An order of devices in the multi-device environment may be received at 1330 indicating the order and number of devices in the multi-device environment. Operation according to the order of devices may commence at 1340. The order of devices may be relevant for the operation of certain programs or applications, or for determining the dominant device when performing specific operations.

In an example embodiment, an apparatus for performing the methods of FIGS. 14 and 15 above may comprise a processor (e.g., the processor 40) configured to perform some or each of the operations (1210-1230 and/or 1310-1340) described above. The processor may, for example, be configured to perform the operations (1210-1230 and/or 1310-1340) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 1210-1230 and/or 1310-1340 may comprise, for example, the processor 40 and/or a device or circuit for executing instructions or executing an algorithm for processing information as described above.

As described above and as will be appreciated by one skilled in the art, embodiments of the present invention may be configured as a system, method or electronic device. Accordingly, embodiments of the present invention may be comprised of various means including entirely of hardware or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
directing a presentation of a first image by a processor on a display of a device configured to operate in a multi-device environment;
detecting a motion of the device; and
directing a change of an image presented on the display of the device from the first image to a second image in response to detecting the motion of the device;
wherein the first image displayed on the device is related to images displayed on other devices in the multi-device environment.

2. A method according to claim 1, wherein the second image is a scaled version of the first image.

3. A method according to claim 2, further comprising scaling the second image based on at least one property of the motion.

4. A method according to claim 1, wherein each device in the multi-device environment is directed to present a portion of a complete image, and wherein the first image is a portion of the complete image.

5. A method according to claim 1, further comprising directing at least one other device in the multi-device environment to change an image presented on the display of said at least one other device in response to the detected motion of the device.

6. A method according to claim 1, wherein the motion of the device includes moving the device from a first location and wherein the method further comprises again directing presentation of the first image on the device in response to detection that the device has returned to the first location.

7. A method according to claim 1, wherein the second image is an expanded view of the first image including information not present in the first image.

8. An apparatus comprising at least one processor and at least one memory including computer program code, the at least one memory and the computer program code configured to, with the at least one processor, cause the apparatus to at least perform:
direct presentation of a first image on a display of a device configured to operate in a multi-device environment;
detect a motion of the device; and
direct a change of an image presented on the display of the device from the first image to a second image in response to detecting the motion of the device;
wherein the first image displayed on the device is related to images displayed on other devices in the multi-device environment.

9. An apparatus according to claim 8, wherein the second image is a scaled version of the first image.

10. An apparatus according to claim 9, wherein the at least one memory and the computer program code are configured to, with the at least one processor, cause the apparatus to scale the second image is based on at least one property of the motion.

11. An apparatus according to claim 8, wherein the at least one memory and the computer program code are configured to, with the at least one processor, cause the apparatus to present a portion of a complete image, and wherein the first image is a portion of the complete image.

12. An apparatus according to claim 8, wherein the at least one memory and the computer program code are configured to, with the at least one processor, cause the apparatus to direct at least one other device in the multi-device environment to change an image presented on the display of said at least one other device in response to the detected motion of the device.

13. An apparatus according to claim 8, wherein the motion of the device includes moving the device from a first location and wherein the apparatus is further caused to again direct presentation of the first image on the device in response to detection that the device has returned to the first location.

14. An apparatus according to claim 8, wherein the second image is an expanded view of the first image displaying information not present in the first image.

15. A computer program product comprising at least one computer-readable storage medium having computer-executable program code instructions stored therein, the computer-executable program code instructions comprising:
program code instructions for directing presentation of a first image on a display of a device configured to operate in a multi-device environment;
program code instructions for detecting a motion of the device;
program code instructions for directing a change of an image presented on the display of the device from the first image to a second image in response to detecting the motion of the device;
wherein the first image displayed on the device is related to images displayed on other devices in the multi-device environment.

16. A computer program product according to claim 15, wherein the second image is a scaled version of the first image.

17. A computer program product according to claim 16, further comprising program code instructions for scaling the second image based at least on one property of the motion.

18. A computer program product according to claim 15, further comprising program code instructions to cause each device in the multi-device environment to present a portion of a complete image, and wherein the first image is a portion of the complete image.

19. A computer program product according to claim 15, further comprising program code instructions for causing at least one other device in the multi-device environment to change an image presented on the display of said at least one other device in response to the detected motion of the device.

20. A computer program product according to claim 15, wherein the motion of the device includes moving the device from a first location and wherein the computer program product further comprises program code instructions for again directing presentation of the first image on the device in response to the device being returned to the first location.
